(19) United States
(12) Patent Application Publication
(10) Pub. No.: US 2011/0154425 A1
(43) Pub. Date: Jun. 23, 2011

(54) HEADEND APPARATUS FOR TRANSMITTING VIDEO BROADCAST CONTENT USING CHANNEL BONDING, AND BROADCAST RECEIVING APPARATUS AND METHOD FOR RECEIVING VIDEO BROADCAST CONTENT

(75) Inventors: Sung-Hoon KIM, Daejeon (KR); Sun Sik RHO, Gwangju (KR)

(73) Assignees: ELECTRONICS AND TELECOMMUNICATIONS RESEARCH INSTITUTE, DAEJEON (KR); INDUSTRY ACADEMIC COOPERATION OF GWANGJU UNIVERSITY, GWANGJU (KR)

(21) Appl. No.: 12/900,042

(22) Filed: Oct. 7, 2010

(30) Foreign Application Priority Data
Dec. 17, 2009 (KR) 10-2009-0126216
Mar. 22, 2010 (KR) 10-2010-0025218

(51) Int. Cl. H04N 7/173

(52) U.S. Cl. 725/116

(57) ABSTRACT

A headend apparatus for communicating with a broadcast receiving apparatus through a cable network comprising a plurality of transmission channels is provided. The headend apparatus includes a receiver to receive a video broadcast content corresponding to a selected broadcast channel, a plurality of modulators to modulate the video broadcast content, each individual modulator of the plurality of modulators being mapped to an individual transmission channel of the plurality of transmission channels, and a controller to determine whether to bond the plurality of transmission channels, based on a definition of the video broadcast content, and to control the modulators to bond the plurality of transmission channels and transmit the video broadcast content to the broadcast receiving apparatus when determining to bond the plurality of transmission channels, each individual modulator of the plurality of modulators being mapped to the bonded transmission channels.

### CROSS-REFERENCE TO RELATED APPLICATIONS

This application claims the benefit of Korean Patent Application No. 10-2009-0126216 and of Korean Patent Application No. 10-2010-0025218, respectively filed on Dec. 17, 2009 and Mar. 22, 2010, in the Korean Intellectual Property Office, the disclosures of which are incorporated herein by reference.

### BACKGROUND

1. Field of the Invention

The present invention relates to a headend apparatus for transmitting a video broadcast content using a channel bonding, and a broadcast receiving apparatus and method for receiving a video broadcast content. More particularly, the present invention relates to a headend apparatus, a broadcast receiving apparatus, and a method for transmitting and receiving a video broadcast content that may transmit an Ultra High Definition (UHD) video broadcast content to a subscriber through a channel bonding.

2. Description of the Related Art

In a cable network, each individual transmission channel (namely, a frequency channel) is assigned to each individual video broadcast content, and a single video broadcast content is transmitted to a broadcast receiving apparatus of a subscriber through a transmission channel assigned to the video broadcast content. Specifically, a single video broadcast content is transmitted using a Moving Picture Experts Group-2 (MPEG-2) Transport Stream (TS) packet stream. The video broadcast content is modulated by Quadrature Amplitude Modulation (QAM) transmission devices of a headend in a cable network, and the modulated video broadcast content is transmitted to a broadcast receiving apparatus of a subscriber.

A standard organization for a digital broadcasting cable provides a 256-QAM single carrier wave scheme as a Hybrid Fibre-Coaxial (HFC) downstream channel transmission standard. However, since 2009, 1024-QAM and 4096-QAM have been developed and proposed to increase a transmission efficiency and to transmit large capacity data.

To provide high quality video broadcast contents, High-Definition television (HDTV) broadcast services are currently being provided. However, Ultra High Definition TV (UHDTV) broadcast services are increasingly being developed due to viewers' demands for ultra high quality.

UHDTV broadcast services provide video broadcast contents with an ultra high quality, for example 4K (3840×2160 pixels) and 8K (7680×4320 pixels), that are 4 to 16 times more vivid than an image quality provided by conventional HDTVs. When 4K and 8K video broadcast contents are not compressed, transmission rates of 5 gigabit per second (Gbps) and 20 Gbps may be required. When 4K and 8K video broadcast contents are compressed by a factor of 100, transmission rates of 50 megabit per second (Mbps) and 200 Mbps may be required. Additionally, when a 1024-QAM is used, a 4K video broadcast content may be transmitted through a single transmission channel, whereas it may be difficult to transmit an 8K video broadcast content through a single transmission channel. Thus, there is a desire for a transmission technology that may bond a plurality of channels to transmit 8K video broadcast contents when UHDTV broadcast services are provided.

### SUMMARY

An aspect of the present invention provides a headend apparatus that may determine whether to bond transmission channels, based on a definition of a received video broadcast content, and may transmit service transmission information containing channel bonding information to a broadcast receiving apparatus of a subscriber, to provide a video broadcast content with an Ultra High Definition (UHD).

Another aspect of the present invention provides a broadcast receiving apparatus and method that may respectively transmission channels to Quadrature Amplitude Modulation (QAM) demodulators based on service transmission information received from a headend apparatus, and may receive an UHD video broadcast content.

According to an aspect of the present invention, there is provided a headend apparatus for communicating with a broadcast receiving apparatus through a cable network including a plurality of transmission channels, the headend apparatus including: a receiver to receive a video broadcast content corresponding to a selected broadcast channel; a plurality of modulators to modulate the video broadcast content, each individual modulator of the plurality of modulators being mapped to an individual transmission channel of the plurality of transmission channels; and a controller to determine whether to bond the plurality of transmission channels, based on a definition of the video broadcast content, and to control the modulators to bond the plurality of transmission channels and transmit the video broadcast content to the broadcast receiving apparatus when determining to bond the plurality of transmission channels, each individual modulator of the plurality of modulators being mapped to the bonded transmission channels.

According to another aspect of the present invention, there is provided a broadcast receiving apparatus for receiving a video broadcast content from a headend apparatus through a plurality of transmission channels that are formed on a cable network, the broadcast receiving apparatus including: a plurality of demodulators; and a controller to assign at least one transmission channel among the plurality of transmission channels to at least one demodulator among the plurality of demodulators based on channel bonding information, and to receive the video broadcast content, when service transmission information containing the channel bonding information is received through the at least one demodulator.

According to another aspect of the present invention, there is provided a method of receiving a video broadcast content in a broadcast receiving apparatus, the method including: receiving service transmission information containing channel bonding information regarding a plurality of transmission channels from a headend apparatus through the plurality of transmission channels, the plurality of transmission channels being formed on a cable network; receiving a video broadcast content from the headend apparatus through at least one transmission channel among the plurality of transmission channels, based on the channel bonding information; and demodulating the video broadcast content using at least one demodulator, each individual demodulator among the at least one demodulator being mapped to an individual transmission channel among the at least one transmission channel.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a broadcast system according to an embodiment of the present invention;

FIG. 2 is a diagram illustrating service transmission information according to an embodiment of the present invention;

FIG. 3 is a diagram illustrating a channel information table according to an embodiment of the present invention;

FIG. 4 is a flowchart illustrating a method of transmitting a video broadcast content in a headend apparatus according to an embodiment of the present invention; and

FIG. 5 is a flowchart illustrating a method of receiving a video broadcast content in a broadcast receiving apparatus according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

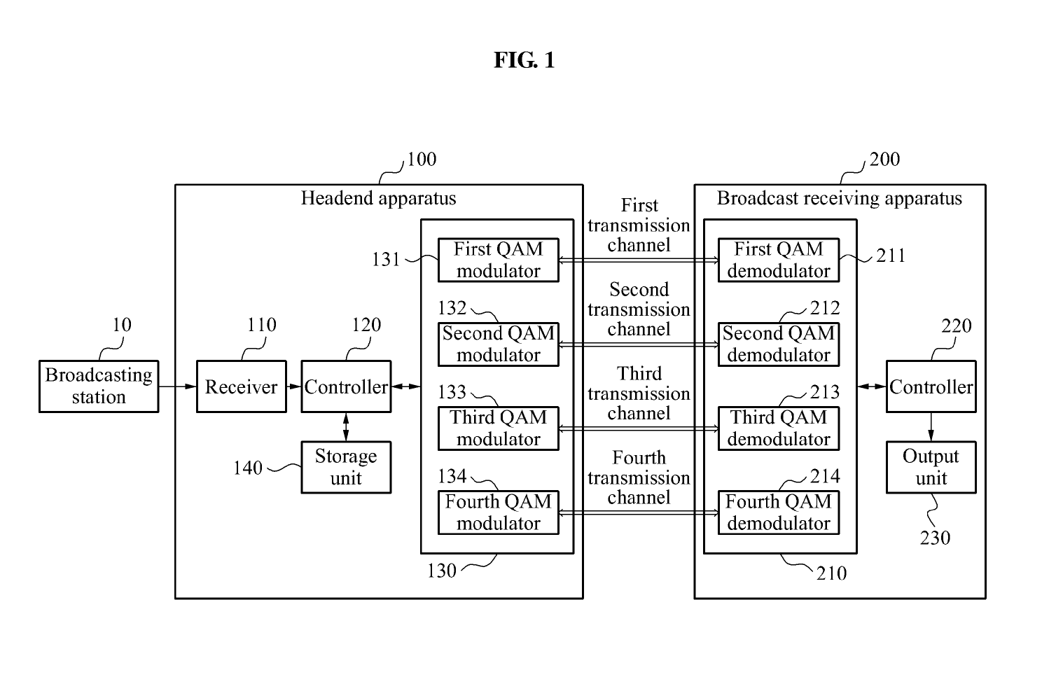

FIG. 1 is a diagram illustrating a broadcast system according to an embodiment of the present invention. Referring to FIG. 1, the broadcast system includes a broadcasting station 10, a headend apparatus 100, and a broadcast receiving apparatus 200. Here, a video broadcast content may be transmitted and received by the headend apparatus 100 and the broadcast receiving apparatus 200. Configurations and operations of the headend apparatus 100 and the broadcast receiving apparatus 200 will be described below.

The broadcasting station 10 may generate a video broadcast content, and may provide the generated video broadcast content. Specifically, the broadcasting station 10 may provide the headend apparatus 100 with video broadcast contents corresponding to multiple broadcast channels.

When a signal to select a predetermined broadcast channel is received from the broadcast receiving apparatus 200, the headend apparatus 100 may transmit a video broadcast content corresponding to the predetermined broadcast channel to the broadcast receiving apparatus 200. Here, FIG. 1 shows only a single broadcast receiving apparatus 200 is contained in the broadcast system for ease of description, however, the headend apparatus 100 may be connected to a plurality of broadcast receiving apparatuses in an actual broadcast system.

The headend apparatus 100 may communicate with the broadcast receiving apparatus 200 through a cable network including a plurality of transmission channels, to transmit or receive various signals to or from the broadcast receiving apparatus 200 through the plurality of transmission channels. Here, the cable network may have a Data Over Cable Service Interface Specification (DOCSIS) 3.0 transmission standard based on a Hybrid Fiber Coax (HFC).

The DOCSIS 3.0 transmission standard may enable “channel bonding” so that at least two transmission channels may be bonded to transmit a large amount of data. Accordingly, the headend apparatus 100 may determine whether to bond the transmission channels, based on a definition of the video broadcast content. When the transmission channels are determined to be bonded, the headend apparatus 100 may bond at least two transmission channels among the plurality of transmission channels, and may transmit the video broadcast content to the broadcast receiving apparatus 200.

Referring to FIG. 1, the headend apparatus 100 includes a receiver 110, a controller 120, a modulator 130, and a storage unit 140.

The receiver 110 may receive a video broadcast content provided by the broadcasting station 10.

The modulator 130 may modulate the video broadcast content, and may transmit the modulated video broadcast content to the broadcast receiving apparatus 200. Additionally, the modulator 130 may include a plurality of Quadrature Amplitude Modulation (QAM) modulators, namely, a first QAM modulator 131, a second QAM modulator 132, a third QAM modulator 133, and a fourth QAM modulator 134, as shown in FIG. 1. While FIG. 1 shows the first through fourth QAM modulators 131 through 134, there is no limitation to a number of QAM modulators included in the modulator 130. The first through fourth QAM modulators 131 through 134 may have one of various modulation schemes, for example 64-QAM, 128-QAM, 256-QAM, and 1024-QAM modulation schemes, and may desirably have the 1024-QAM modulation scheme. Additionally, the first through fourth QAM modulators 131 through 134 may desirably have the same modulation scheme, but there is no limitation thereto.

Each individual module of the first through fourth QAM modulators 131 through 134 may be mapped to an individual transmission channel of the plurality of transmission channels. Accordingly, the first through fourth QAM modulators 131 through 134 may transmit a variety of data, for example a video broadcast content, through the transmission channels.

The storage unit 140 may store a channel information table. The channel information table may be used to manage a broadcast channel, and channel identifications (IDs) of transmission channels bonded to transmit a video broadcast content. For example, when a broadcast channel “11” is selected and when a first transmission channel, a second transmission channel, a third transmission channel and a fourth transmission channel are bonded to transmit a video broadcast content corresponding to the broadcast channel “11,” the storage unit 140 may record the broadcast channel “11,” and channel IDs “CH1”, “CH2”, “CH3”, “CH4” of the bonded transmission channels on the channel information table, and may manage the channel information table.

The controller 120 may control every element of the headend apparatus 100, to transmit a video broadcast content. Specifically, when a signal to select a predetermined broadcast channel is received from the broadcast receiving apparatus 200, the controller 120 may receive a video broadcast content corresponding to the predetermined broadcast channel from the broadcasting station 10, and may check a definition of the received video broadcast content. Here, the definition of the video broadcast content may be represented by a vertical scanning line and a horizontal scanning line of the video broadcast content and thus, information on the vertical scanning line and horizontal scanning line may be detected to check the definition of the video broadcast content.

Additionally, when the definition of the video broadcast content is checked, the controller 120 may determine whether to bond the plurality of transmission channels based on the definition of the video broadcast content. Here, the video broadcast content may be a kind of data, for example video data and audio data. A data capacity that is to be supported may increase as a definition increases, and a transmission rate that is to be supported may increase as the data capacity increases. In other words, the definition of the video broadcast content may be proportional to a transmission rate of the video broadcast content. However, even when the 1024-QAM modulation scheme is used by the first through fourth QAM modulators 131 through 134, only a maximum rate transmission rate of 50 megabit per second (Mbps) may be supported by a single transmission channel in the cable network. Accordingly, a transmission rate of 50 Mbps may be sufficient when a high quality video broadcast content with a definition of 4K (3840×2160 pixels) is compressed by a factor of 100 and thus, only a single transmission channel may be used to transmit the compressed video broadcast content. However, a transmission rate of 200 Mbps may be used even when an ultra high quality video broadcast content with a definition of 8K (7680×4320 pixels) is compressed by a factor of 100 and thus, it may be difficult to transmit the video broadcast content through a single transmission channel.

As described above, when a first transmission rate corresponding to a definition of a video broadcast content does not exceed a second transmission rate supported by a single transmission channel, the controller 120 may determine not to bond the transmission channels. Conversely, when the first transmission rate exceeds the second transmission rate, the controller 120 may determine to bond the transmission channels, and may determine a number of transmission channels to be bonded. After whether to bond the transmission channels is determined, the controller 120 may generate channel bonding information based on a result of the determining, and may also generate service transmission information containing the channel bonding information.

Here, the service transmission information may be used to notify the broadcast receiving apparatus 200 of transmission characteristics of a video broadcast content, namely bonding characteristics of transmission channels. The service transmission information may include operation state information of the headend apparatus 100 as well as the channel bonding information. The operation state information may include information regarding at least one of an initialization state, an activation state, a scheduling state and a channel change state. Additionally, the channel bonding information may include channel bonding state information regarding whether a plurality of transmission channels are bonded, channel bonding type information regarding a number of bonded transmission channels, channel bonding order information regarding a bonding order of a plurality of transmission channels, channel bonding order change information regarding a change in the bonding order, and channel ID information regarding channel IDs of bonded transmission channels.

The controller 120 may transmit the service transmission information containing the channel bonding information to the broadcast receiving apparatus 200 through at least one transmission channel that is mapped to at least one QAM modulator among the first through fourth QAM modulators 131 through 134.

When the service transmission information is transmitted to the broadcast receiving apparatus 200, the controller 120 may transmit a video broadcast content to the broadcast receiving apparatus 200. Specifically, the controller 120 may transmit the video broadcast content to the broadcast receiving apparatus 200 based on the channel bonding information. For example, when the channel bonding information indicates an “unbonded channel” state, the controller 120 may modulate the video broadcast content using a QAM modulator among the first through fourth QAM modulators 131 through 134, and may transmit the modulated video broadcast content to the broadcast receiving apparatus 200 through a transmission channel that is mapped to the used QAM modulator. Conversely, when the channel bonding information indicates a “four-bonded channel” state, the controller 120 may divide the video broadcast content into four content segments, and may modulate the four content segments using the first through fourth QAM modulators 131 through 134, respectively. Additionally, the controller 120 may transmit the modulated video broadcast content to the broadcast receiving apparatus 200 through transmission channels that are respectively mapped to the first through fourth QAM modulators 131 through 134.

As described above, the headend apparatus 100 may transmit the video broadcast content to the broadcast receiving apparatus 200 through the plurality of transmission channels and thus, it is possible to provide the broadcast receiving apparatus 200 with a video broadcast content with an Ultra High Definition (UHD) of 8K (7680×4320 pixels).

The broadcast receiving apparatus 200 may be used by a subscriber, and may be implemented by a broadcast receiver, for example a Set-Top Box (STB), or a TV with an STB. As described above, the broadcast receiving apparatus 200 may communicate with the headend apparatus 100 via a cable network including a plurality of transmission channels.

Referring to FIG. 1, the broadcast receiving apparatus 200 includes a demodulator 210, a controller 220, and an output unit 230.

The demodulator 210 may demodulate the service transmission information and video broadcast content that are received from the headend apparatus 100. Additionally, the demodulator 210 may include a plurality of QAM demodulators, namely, a first QAM demodulator 211, a second QAM demodulator 212, a third QAM demodulator 213, and a fourth QAM demodulator 214, as shown in FIG. 1. FIG. 1 shows only the first through fourth QAM demodulators 211 through 214 for ease of description, however, there is no limitation to a number of QAM demodulators included in the demodulator 210.

Additionally, the first through fourth QAM demodulators 211 through 214 may have one of various demodulation schemes, for example 64-QAM, 128-QAM, 256-QAM, and 1024-QAM demodulation schemes, and may desirably have the 1024-QAM demodulation scheme. Additionally, the first through fourth QAM demodulators 211 through 214 may desirably have the same demodulation scheme, but there is no limitation thereto.

When service transmission information containing channel bonding information is received through at least one QAM demodulator among the first through fourth QAM demodulators 211 through 214, the controller 220 may respectively assign first through fourth transmission channels to the first through fourth QAM demodulators 211 through 214 based on the channel bonding information, and may receive a video broadcast content. Here, the service transmission information may further include the operation state information of the headend apparatus 100, as well as the channel bonding information. Additionally, the service transmission information may be recorded on a frame synchronization trailer packet of the video broadcast content.

Specifically, when the service transmission information is received, the controller 220 may check channel ID information contained in the channel bonding information, and may determine whether a main transmission channel is assigned to at least one QAM demodulator among the first through fourth QAM demodulators 211 through 214. The channel ID information may include, for example, transmission channel IDs that are arranged and are used when a video broadcast content is transmitted, and a channel ID placed in front of other channel IDs may be used to identify a main transmission channel. The main transmission channel may be a channel set in advance to transmit a video broadcast content by the headend apparatus 100, and a sub-transmission channel may be a transmission channel bonded to the main transmission channel to transmit a video broadcast content in the headend apparatus 100. Specifically, when the headend apparatus 100 bonds the second through fourth transmission channels to transmit a video broadcast content, the first transmission channel may be set as a main transmission channel, and the second through fourth transmission channels may be set as sub-transmission channels. Additionally, the headend apparatus 100 may generate channel ID information as information on the set transmission channels, and may insert the channel ID information into the channel bonding information.

When the main transmission channel is determined to be assigned to the at least one QAM demodulator, the controller 220 may assign at least one transmission channel to at least one QAM demodulator based on the operation state information or the channel bonding type information contained in the service transmission information. Specifically, when the operation state information indicates the initialization state or the activation state, the controller 220 may determine whether a first main transmission channel of a previous transmission period is identical to a second main transmission channel of a current transmission period. Here, the previous transmission period and the current transmission period may be associated with the video broadcast content. Additionally, the first main transmission channel may be recorded on a recording medium (not shown) of the broadcast receiving apparatus 200.

When the first main transmission channel is determined to be identical to the second main transmission channel, the controller 220 may determine that the same video broadcast content is received through the same transmission channel in both of the previous transmission period and the current transmission period, and may wait until service transmission information for a next transmission period is received.

When the first main transmission channel is determined to differ from the second main transmission channel, the controller 220 may determine that a video broadcast content and a transmission channel are changed in the current transmission period, and may check the channel bonding state information and the channel bonding type information. The channel bonding state information may indicate whether the plurality of transmission channels are bonded, and the channel bonding type information may indicate a number of bonded transmission channels. In other words, the controller 220 may determine whether the plurality of transmission channels are bonded, and the number of bonded transmission channels, and may perform an operation based on a result of the determining. For example, when the channel bonding state information indicates an “unbonded channel” state, the controller 220 may control a QAM demodulator, to which the main transmission channel is assigned, to receive the video broadcast content through the second main transmission channel and to demodulate the received video broadcast content.

Conversely, when the channel bonding state information indicates a “bonded channel” state, and when the channel bonding type information indicates a “four-bonded channel,” the controller 220 may respectively assign three sub-transmission channels other than the main transmission channel to three QAM demodulators. For example, when the first transmission channel assigned to the first QAM demodulator 211 is set as a main transmission channel, and when the second through fourth transmission channels are set as sub-transmission channels, the controller 220 may respectively assign the second through fourth transmission channels to the second through fourth QAM demodulators 212 through 214. In this example, the controller 220 may check the channel ID information contained in the service transmission information, and may determine which transmission channel is assigned. Additionally, the controller 220 may check the channel bonding order information, and may determine a bonding order of transmission channels.

When the operation state information indicates the channel change state, not the initialization state or the activation state, the controller 220 may check the channel bonding state information and the channel bonding type information, and may perform the operation as described above, based on the channel bonding state and the “number of bonded channels”. The first through fourth QAM demodulators 211 through 214 may receive the video broadcast content through the first through fourth transmission channels that are respectively assigned to the first through fourth QAM demodulators 211 through 214, and may demodulate the received video broadcast content.

The output unit 230 may be configured in different forms based on a type of the broadcast receiving apparatus 200. For example, when the broadcast receiving apparatus 200 is implemented by a broadcast receiver, such as an STB, the output unit 230 may be implemented depending on a type of communication unit to transmit a demodulated video broadcast content to a display device, such as a TV. Alternatively, when the broadcast receiving apparatus 200 is implemented by a TV, the output unit 230 may be implemented by a display unit to display a demodulated video broadcast content on a screen.

As shown in FIG. 1, the headend apparatus 100 may determine whether to bond the plurality of transmission channels based on the definition of the video broadcast content, and may transmit the service transmission information containing the channel bonding information to the broadcast receiving apparatus 200. Additionally, the broadcast receiving apparatus 200 may check the service transmission information, and may receive the video broadcast content through the plurality of transmission channels. Accordingly, it is possible to use a UHD video broadcast content with a definition, for example 8K (7680×4320 pixels), regardless of the transmission rate by bonding the plurality of transmission channels.

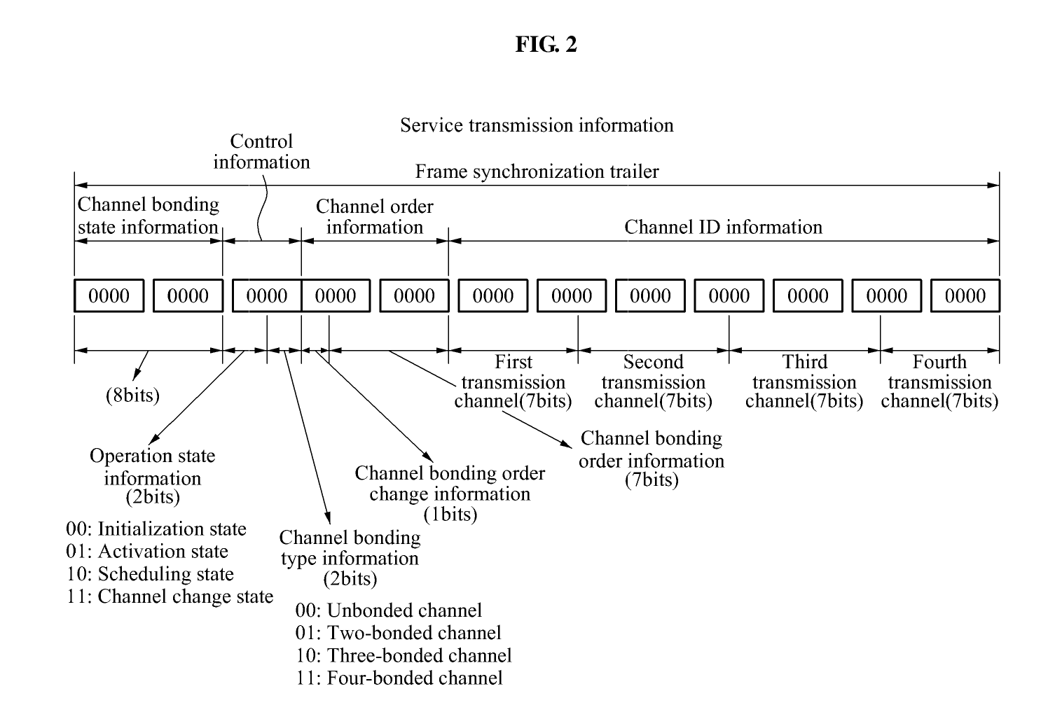

FIG. 2 is a diagram illustrating service transmission information according to an embodiment of the present invention. The service transmission information of FIG. 2 may be contained in a video broadcast content. Specifically, the video broadcast content may be transmitted as a digital transmission frame, and the service transmission information may be recorded on a frame synchronization trailer packet of the digital transmission frame. Here, the frame synchronization trailer packet may have 48-bit data.

The service transmission information may be generated by the headend apparatus 100, and may include operation state information of the headend apparatus 100, and channel bonding information. Additionally, the channel bonding information may include channel bonding state information, channel bonding type information, channel bonding order change information, channel bonding order information, and channel ID information. The operation state information and the channel bonding type information may be used as control information.

The channel bonding state information may include 8-bit data, and may indicate whether transmission channels are bonded. Specifically, the channel bonding state information may include information regarding a bonded channel state “00000000”, or an unbonded channel state “11111111”.

The operation state information may include 2-bit data, and may show the operation state of the headend apparatus 100. Specifically, the operation state information may include information regarding at least one of an initialization state “00”, an activation state “01”, a scheduling state “10”, and a channel change state “11”. Here, the initialization state “00” may indicate a state where the headend apparatus 100 is reactivated or a cable network is initialized, and the activation state “01” may indicate a state where a video broadcast content is being transmitted.

Additionally, the scheduling state “10” may indicate a state where a video broadcast content is scheduled to be transmitted, and the channel change state “11” may indicate a state where a transmission channel for transmitting a video broadcast content or a broadcast channel is changed.

The channel bonding type information may represent the number of bonded transmission channels, and may include information regarding at least one of an “unbonded channel” state “00”, a “two-bonded channel” state “01”, a “three-bonded channel” state “10”, and a “four-bonded channel” state “11”.

Additionally, channel order information may include channel bonding order information, and channel bonding order change information. Specifically, the channel bonding order information may represent a bonding order of at least two transmission channels when the at least two transmission channels are bonded. For example, when at least two transmission channels are bonded, a video broadcast content may be divided into content segments by a data unit corresponding to the number of bonded transmission channels. The content segments into which the video broadcast content is divided may be distributed to each of the transmission channels, and may be transmitted to the broadcast receiving apparatus 200. In other words, the channel bonding order information may be used to enable the broadcast receiving apparatus 200 to sequentially receive the video broadcast content.

The channel bonding order change information may indicate a state where a bonding order of a plurality of transmission channels is changed. Specifically, the headend apparatus 100 may change a transmission channel while transmitting a video broadcast content. The headend apparatus 100 may set a “changed channel bonding order” state and an “unchanged channel bonding order” state as “1” and “0”, respectively, and may record “0” and “1” on the service transmission information.

The channel ID information may include channel IDs of bonded transmission channels, and a maximum number of channel IDs contained in the channel ID information may be four. Each channel ID may include 7-bit data. The channel ID information may contain frequency information of transmission channels. Accordingly, when the service transmission information is received, the broadcast receiving apparatus 200 may check the frequency information, and may assign transmission channels to at least one QAM demodulator among the first through fourth QAM demodulators 211 through 214.

Referring to FIG. 2, a first transmission channel located in a head portion of the channel ID information may be set as a main transmission channel, and second through fourth transmission channels may be set as sub-transmission channels. For example, when the first through fourth transmission channels are bonded to transmit the same video broadcast content, service transmission information may be generated for each of the first through fourth transmission channels. In this example, the generated service transmission information may contain the same channel ID information.

The service transmission information of FIG. 2 is merely an example of the present invention. Accordingly, an arrangement order of the operation state information and the channel bonding information contained in the service transmission information may be changed depending on circumstances.

Also, an arrangement order of the channel bonding state information, the channel bonding type information, the channel bonding order information, the channel bonding order change information, and the channel ID information that are contained in the channel bonding information may be changed depending on circumstances. Data value may also be changed based on each state. In other words, when all of the information contained in the service transmission information is recorded on a frame synchronization trailer packet of the video broadcast content, and is transmitted, the arrangement order or an actual data value may be changed.

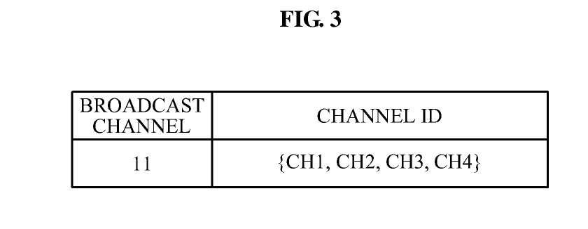

FIG. 3 is a diagram illustrating a channel information table according to an embodiment of the present invention. The channel information table of FIG. 3 may be used to manage a broadcast channel, and channel IDs of transmission channels bonded to transmit a video broadcast content. Specifically, in FIG. 3, a current broadcast channel “11”, and channel IDs “CH1”, “CH2”, “CH3”, and “CH4” are recorded on the same row of the channel information table. Here, the channel IDs “CH1”, “CH2”, “CH3”, and “CH4” may identify transmission channels bonded to transmit a video broadcast content corresponding to the current broadcast channel “11”. As described above, the headend apparatus 100 may record and manage a current broadcast channel and bonded transmission channels, before transmitting a video broadcast content corresponding to the current broadcast channel to the broadcast receiving apparatus 200.

While the channel information table of FIG. 3 includes only information on the current broadcast channel and the channel IDs of the bonded transmission channels corresponding to the current broadcast channel, there is no limitation thereto. Accordingly, a previous broadcast channel, and channel IDs of bonded transmission channels corresponding to the previous broadcast channel may be further recorded on the channel information table of FIG. 3.

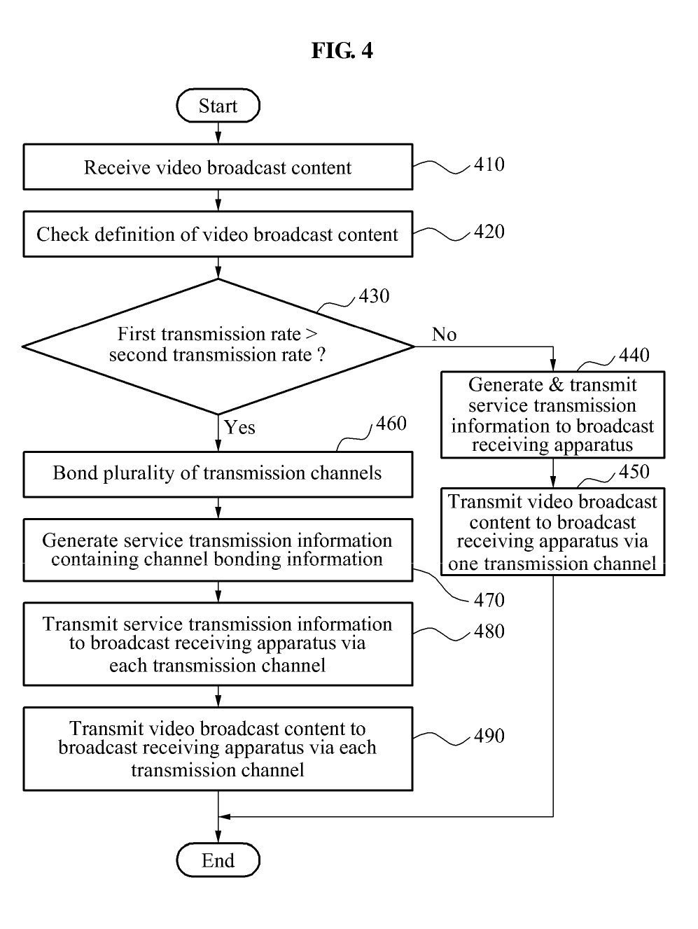

FIG. 4 is a flowchart illustrating a method of transmitting a video broadcast content in a headend apparatus according to an embodiment of the present invention. Referring to FIG. 4, the headend apparatus 100 may receive a video broadcast content corresponding to a predetermined broadcast channel from the broadcasting station 10 in operation 410.

Subsequently, the headend apparatus 100 may check a definition of the received video broadcast content in operation 420. Here, checking of the definition of the video broadcast content information on a vertical scanning line and a horizontal scanning line contained in the video broadcast content may be used.

The headend apparatus 100 may determine whether a first transmission rate corresponding to the definition of the video broadcast content exceeds a second transmission rate supported by a single transmission channel in operation 430. As a result, when the first transmission rate does not exceed the second transmission rate, the headend apparatus 100 may generate service transmission information for a single transmission channel, and may transmit the generated service transmission information to the broadcast receiving apparatus 200 in operation 440. Additionally, the headend apparatus 100 may modulate the video broadcast content, and may transmit the modulated video broadcast content to the broadcast receiving apparatus 200 through a single transmission channel in operation 450. For example, when both of the first transmission rate and the second transmission rate are 50 Mbps, the headend apparatus 100 may transmit the video broadcast content through only a single transmission channel, without bonding transmission channels.

Conversely, when the first transmission rate exceeds the second transmission rate, the headend apparatus 100 may bond a plurality of transmission channels in operation 460. Here, a number of transmission channels to be bonded may be determined to be within a range meeting the first transmission rate.

The headend apparatus 100 may generate channel bonding information associated with bonding of the transmission channels, and may generate service transmission information containing the channel bonding information in operation 470. Here, the service transmission information may further include operation state information of the headend apparatus 100, in addition to the channel bonding information.

The headend apparatus 100 may transmit the service transmission information to the broadcast receiving apparatus 200 through each of the bonded transmission channels in operation 480, and may transmit the video broadcast content to the broadcast receiving apparatus 200 through each of the bonded transmission channels in operation 490.

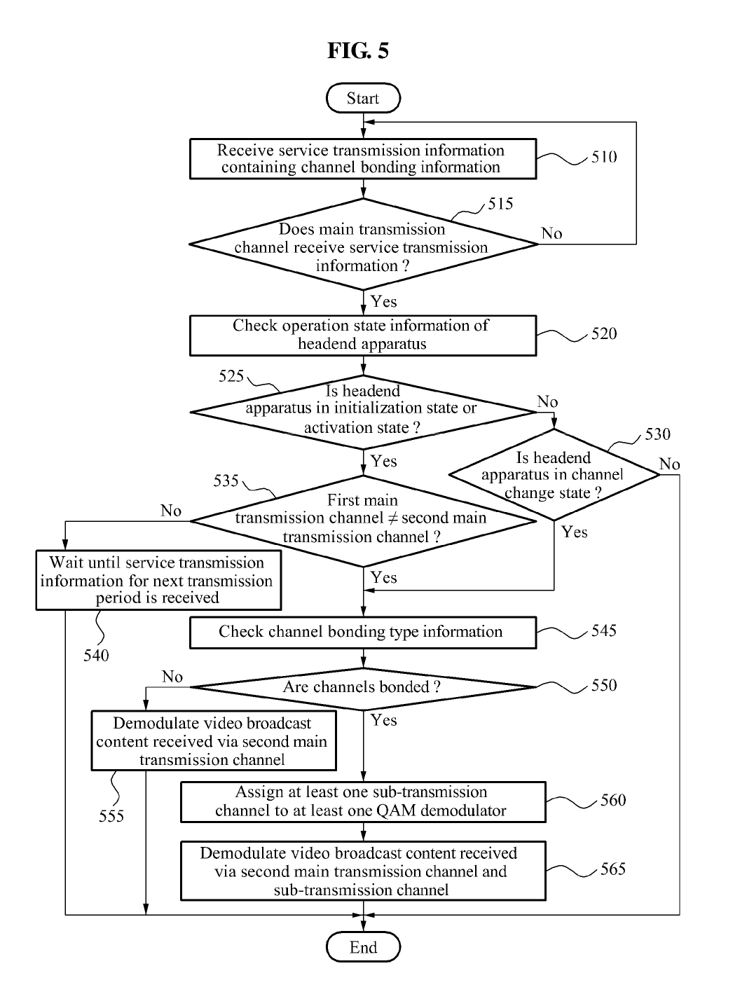

FIG. 5 is a flowchart illustrating a method of receiving a video broadcast content in a broadcast receiving apparatus according to an embodiment of the present invention. Referring to FIG. 5, the broadcast receiving apparatus 200 may receive service transmission information containing channel bonding information from the headend apparatus 100 in operation 510. Here, the service transmission information may be recorded on a frame synchronization trailer packet of a video broadcast content that is transmitted as a digital transmission frame.

Subsequently, the broadcast receiving apparatus 200 may determine whether a main transmission channel receives the service transmission information in operation 515. Channel ID information contained in the channel bonding information may be used to determine whether a main transmission channel or a sub-transmission channel is used. For example, channel IDs of bonded transmission channels may be arranged in the channel ID information for each 7-bit data. Additionally, a channel ID located in a head portion of the channel ID information may be set as a channel ID of a main transmission channel, and other arranged channel IDs may be set as channel IDs of sub-transmission channels.

As a result of operation 515, when the main transmission channel is determined to receive the service transmission information, the broadcast receiving apparatus 200 may check the operation state information of the headend apparatus 100 by checking the service transmission information in operation 520. When the headend apparatus 100 is operated in an initialization state or an activation state in operation 525, the broadcast receiving apparatus 200 may determine whether a first main transmission channel of a previous transmission period differs from a second main transmission channel of a current transmission period in operation 535. When the first main transmission channel is determined to be identical to the second main transmission channel in operation 535, the broadcast receiving apparatus 200 may wait until service transmission information for a next transmission period is received in operation 540. In other words, the broadcast receiving apparatus 200 may determine that the same video broadcast content is received in both of the previous transmission period and the current transmission period, and may not perform any operation associated with channel bonding.

Conversely, when the first main transmission channel is determined to differ from the second main transmission channel in operation 535, the broadcast receiving apparatus 200 may check channel bonding type information in the channel bonding information by checking the channel bonding information in operation 545. Additionally, when the headend apparatus 100 is not operated in an initialization state or an activation state as a result of operation 525, the broadcast receiving apparatus 200 may determine whether the headend apparatus 100 is operated in a channel change state in operation 530. When the headend apparatus 100 is determined to be operated in the channel change state in operation 530, the broadcast receiving apparatus 200 may check the channel bonding type information by checking the channel bonding information in operation 545.

When a bonded channel state is determined based on the channel bonding type information in operation 550, the broadcast receiving apparatus 200 may respectively assign at least one sub-transmission channel to at least one QAM demodulator in operation 560. The broadcast receiving apparatus 200 may demodulate a video broadcast content received via the second main transmission channel and the at least one sub-transmission channel assigned to the at least one QAM demodulators in operation 565.

Conversely, when an unbonded channel state is determined in operation 550, the broadcast receiving apparatus 200 may demodulate a video broadcast content received via the second main transmission channel in operation 555.

When the video broadcast contents are completely demodulated as described above, the broadcast receiving apparatus 200 may output the demodulated video broadcast contents to a display device connected to an external source, or may display the demodulated video broadcast contents on a screen to provide a subscriber with the video broadcast contents.

As described above, the broadcast receiving apparatus 200 may check the service transmission information received from the headend apparatus 100, and may receive a video broadcast content through bonding of the plurality of transmission channels. Thus, the broadcast receiving apparatus 200 may use an UHD video broadcast content with a definition, for example 8K (7680×4320 pixels).

According to embodiments of the present invention, a headend apparatus may determine whether to bond transmission channels, based on a definition of a video broadcast content, and may transmit service transmission information containing channel bonding information to a broadcast receiving apparatus of a subscriber. Thus, it is possible to bond a plurality of transmission channels, and to transmit an UHD video broadcast content to the broadcast receiving apparatus.

Additionally, according to embodiments of the present invention, a broadcast receiving apparatus may check service transmission information received from a headend apparatus, may receive an UHD video broadcast content via a plurality of transmission channels based on the service transmission information, and may provide a subscriber with the UHD video broadcast content.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A headend apparatus for communicating with a broadcast receiving apparatus through a cable network comprising a plurality of transmission channels, the headend apparatus comprising:
a receiver to receive a video broadcast content corresponding to a selected broadcast channel;
a plurality of modulators to modulate the video broadcast content, each individual modulator of the plurality of modulators being mapped to an individual transmission channel of the plurality of transmission channels; and
a controller to determine whether to bond the plurality of transmission channels, based on a definition of the video broadcast content, and to control the modulators to bond the plurality of transmission channels and transmit the video broadcast content to the broadcast receiving apparatus when determining to bond the plurality of transmission channels, each individual modulator of the plurality of modulators being mapped to the bonded transmission channels.

2. The headend apparatus of claim 1, wherein the controller generates channel bonding information corresponding to a result of the determining, and controls the plurality of modulators to transmit service transmission information containing the channel bonding information to the broadcast receiving apparatus, each individual modulator of the plurality of modulators being mapped to the bonded transmission channels.

3. The headend apparatus of claim 2, wherein the service transmission information further comprises operation state information of the headend apparatus, the operation state information comprising information regarding at least one of an initialization state, an activation state, a scheduling state, and a channel change state.

4. The headend apparatus of claim 2, wherein the service transmission information is recorded on a frame synchronization trailer packet of the video broadcast content.

5. The headend apparatus of claim 3, wherein the channel bonding information comprises channel bonding state information regarding whether the plurality of transmission channels are bonded, channel bonding type information regarding a number of bonded transmission channels, channel bonding order information regarding a bonding order of the plurality of transmission channels, channel bonding order change information regarding a change in the bonding order, and channel identification (ID) information regarding channel IDs of the bonded transmission channels.

6. The headend apparatus of claim 1, wherein, when a transmission rate corresponding to the definition of the video broadcast content exceeds a transmission rate supported by a transmission channel of the plurality of transmission channels, the controller determines to bond the plurality of transmission channels.

7. The headend apparatus of claim 1, further comprising:
a storage unit to store a channel information table, the channel information table being used to manage the selected broadcast channel, and a channel ID of at least one transmission channel among the plurality of transmission channels, the at least one transmission channel transmitting the video broadcast content.

8. A broadcast receiving apparatus for receiving a video broadcast content from a headend apparatus through a plurality of transmission channels that are formed on a cable network, the broadcast receiving apparatus comprising:
a plurality of demodulators; and
a controller to assign at least one transmission channel among the plurality of transmission channels to at least one demodulator among the plurality of demodulators based on channel bonding information, and to receive the video broadcast content, when service transmission information containing the channel bonding information is received through the at least one demodulator.

9. The broadcast receiving apparatus of claim 8, wherein the service transmission information further comprises operation state information of the headend apparatus, the operation state information comprising information regarding at least one of an initialization state, an activation state, a scheduling state, and a channel change state.

10. The broadcast receiving apparatus of claim 8, wherein the service transmission information is recorded on a frame synchronization trailer packet of the video broadcast content.

11. The broadcast receiving apparatus of claim 9, wherein the channel bonding information comprises channel bonding state information regarding whether the plurality of transmission channels are bonded, channel bonding type information regarding a number of bonded transmission channels, channel bonding order information regarding a bonding order of the plurality of transmission channels, channel bonding order change information regarding a change in the bonding order, and channel ID information regarding channel IDs of the bonded transmission channels.

12. The broadcast receiving apparatus of claim 11, wherein, when the service transmission information containing the channel bonding information is received through at least one demodulator among the plurality of demodulators, the controller checks the channel ID information, determines whether a main transmission channel is assigned to the at least one demodulator, and assigns at least one transmission channel among the plurality of transmission channels to the at least one demodulator based on the operation state information or the channel bonding type information when the main transmission channel is determined to be assigned to the at least one demodulator.

13. The broadcast receiving apparatus of claim 12, wherein, when the operation state information indicates the initialization state or the activation state, the controller determines whether a first main transmission channel of a previous transmission period is identical to a second main transmission channel of a current transmission period, and waits until service transmission information for a next transmission period is received when the first main transmission channel is determined to be identical to the second main transmission channel.

14. The broadcast receiving apparatus of claim 13, wherein, when the first main transmission channel is determined to differ from the second main transmission channel, the controller checks the channel bonding type information, and
when the channel bonding type information indicates an unbonded channel state, the controller controls a demodulator among the plurality of demodulators to receive the video broadcast content through the second main transmission channel, and to demodulate the received video broadcast content, the second main transmission channel being assigned to the demodulator.

15. The broadcast receiving apparatus of claim 13, wherein, when the first main transmission channel is determined to differ from the second main transmission channel, the controller checks the channel bonding type information, and
when the channel bonding type information indicates a bonded channel state, the controller respectively assigns at least one sub-transmission channel to the at least one demodulator based on the number of the bonded transmission channels, controls each of the at least one demodulator to receive the video broadcast content through the second main transmission channel and the sub-transmission channel, and controls each of the at least one demodulator to demodulate the received video broadcast content, the second main transmission channel and the sub-transmission channel being assigned to each of the at least one demodulator.

16. The broadcast receiving apparatus of claim 12, wherein, when the operation state information indicates the channel change state, the controller checks the channel bonding type information, and
when the channel bonding type information indicates an unbonded channel state, the controller controls a demodulator among the plurality of demodulators to receive the video broadcast content through the second main transmission channel, and to demodulate the received video broadcast content, the second main transmission channel being assigned to the demodulator.

17. The broadcast receiving apparatus of claim 12, wherein, when the operation state information indicates the channel change state, the controller checks the channel bonding type information, and
when the channel bonding type information indicates a bonded channel state, the controller respectively assigns at least one sub-transmission channel to the at least one demodulator based on the number of the bonded transmission channels, controls each of the at least one demodulator to receive the video broadcast content through the second main transmission channel and the sub-transmission channel, and controls each of the at least one demodulator to demodulate the received video broadcast content, the second main transmission channel and the sub-transmission channel being assigned to each of the at least one demodulator.

18. A method of receiving a video broadcast content in a broadcast receiving apparatus, the method comprising:
receiving service transmission information containing channel bonding information regarding a plurality of transmission channels from a headend apparatus through the plurality of transmission channels, the plurality of transmission channels being formed on a cable network;
receiving a video broadcast content from the headend apparatus through at least one transmission channel among the plurality of transmission channels, based on the channel bonding information; and
demodulating the video broadcast content using at least one demodulator, each individual demodulator among the at least one demodulator being mapped to an individual transmission channel among the at least one transmission channel.

19. The method of claim 18, wherein the service transmission information is recorded on a frame synchronization trailer packet of the video broadcast content.

20. The method of claim 18, wherein the channel bonding information comprises channel bonding state information regarding whether the plurality of transmission channels are bonded, channel bonding type information regarding a number of bonded transmission channels, channel bonding order information regarding a bonding order of the plurality of transmission channels, channel bonding order change information regarding a change in the bonding order, and channel ID information regarding channel IDs of the bonded transmission channels.
